(19) United States
(12) Patent Application Publication
(10) Pub. No.: US 2025/0342795 A1
(43) Pub. Date: Nov. 6, 2025

(54) PIXEL CIRCUIT AND DISPLAY APPARATUS INCLUDING THE SAME

(71) Applicant: Samsung Display Co., LTD., Yongin-si (KR)

(72) Inventor: JUNGHWAN HWANG, Yongin-si (KR)

(21) Appl. No.: 19/030,476

(22) Filed: Jan. 17, 2025

(30) Foreign Application Priority Data
May 2, 2024 (KR) 10-2024-0058736

(51) Int. Cl. G09G 3/32

(52) U.S. Cl. CPC G09G 3/32; G09G 2300/043; G09G 2300/0819; G09G 2310/08; G09G 2320/0247; G09G 2330/021

(57) ABSTRACT

A pixel circuit includes a first driving transistor including a control electrode connected to a first node, a first electrode and second electrode connected to a second node and third node; a writing transistor for applying a data voltage to the second node; a first and second initialization transistor configured to apply an initialization voltage to the first node and the third node; a second driving transistor including a control electrode connected to a fourth node, a first electrode receiving a first power voltage, and a second electrode connected to a fifth node; a third initialization transistor for applying the initialization voltage to the fourth node; a first capacitor configured to apply a sweep signal to the first node; a second capacitor including a first and second electrode connected to the third node and fourth node; and a light emitting element configured to emit light based on the driving current.

### CROSS-REFERENCE TO RELATED APPLICATION

The present application claims priority to and the benefit of Korean Patent Application No. 10-2024-0058736, filed on May 2, 2024, in the Korean Intellectual Property Office, the entire disclosure of which is incorporated herein by reference.

### BACKGROUND

### 1. Field

Aspects of embodiments of the present disclosure relate to a pixel circuit and a display apparatus including the same.

### 2. Description of the Related Art

Generally, a display apparatus includes a display panel and a display panel driver. The display panel includes a plurality of gate lines, a plurality of data lines, and a plurality of pixels. The display panel driver includes a gate driver providing a gate signal to the gate lines, a data driver providing a data voltage to the data lines, and a driving controller controlling the gate driver, and the data driver.

A conventional pixel circuit driven by pulse width modulation method and performing internal compensation of a threshold voltage may include 19 or more transistors and 3 or more capacitors, so that it is difficult to apply it to an ultra-high-resolution display apparatus due to limitations in integration.

The above information disclosed in this Background section is only for enhancement of understanding of the background of the invention and therefore it may contain information that does not form the prior art.

### SUMMARY

Aspects of embodiments of the present disclosure are directed to a pixel circuit which is driven by pulse width modulation, performs internal compensation of threshold voltage, and includes a small number of transistors, applicable to ultra-high resolution display apparatus.

Aspects of embodiments of the present disclosure are also directed to a display apparatus including the pixel circuit. According to some embodiments of the present disclosure, there is provided a pixel circuit including: a first driving transistor including a control electrode connected to a first node, a first electrode connected to a second node, and a second electrode connected to a third node; a writing transistor configured to apply a data voltage to the second node in response to a compensation gate signal; a first initialization transistor configured to apply an initialization voltage to the first node in response to a first initialization gate signal; a second initialization transistor configured to apply the initialization voltage to the third node in response to a second initialization gate signal; a second driving transistor including a control electrode connected to a fourth node, a first electrode receiving a first power voltage, and a second electrode connected to a fifth node and configured to apply a driving current; a third initialization transistor configured to apply the initialization voltage to the fourth node in response to a third initialization gate signal; a first capacitor configured to apply a sweep signal to the first node; a second capacitor including a first electrode connected to the third node and a second electrode connected to the fourth node; and a light emitting element configured to emit light based on the driving current.

In some embodiments, a width-to-length (W/L) ratio of the second driving transistor may be different based on a color of the light emitting element.

In some embodiments, the pixel circuit may further include: a first emission control transistor configured to apply the first power voltage to the second node in response to a first emission signal; and a second emission control transistor configured to apply the driving current to the light emitting element in response to a second emission signal.

In some embodiments, the pixel circuit may further include: a first compensation transistor configured to connect the first node and the third node in response to the compensation gate signal; and a second compensation transistor configured to connect the fourth node and the fifth node in response to a second compensation gate signal.

In some embodiments, the pixel circuit may further include a fourth initialization transistor configured to apply a second power voltage different from the first power voltage to a first electrode of the light emitting element in response to the second initialization gate signal.

In some embodiments, a writing frame period, in which the pixel circuit is driven, may include an applying period and a first emission period, and in the applying period, the data voltage may be applied to the first node and the initialization voltage may be applied to the fourth node.

In some embodiments, in a first sub-emission period of the first emission period, the first emission signal may have an inactivation level, the second emission signal may have an inactivation level, the second initialization gate signal may have an activation level, and the sweep signal has a first voltage level.

In some embodiments, in a second sub-emission period following the first sub-emission period of the first emission period, the first emission signal may have an activation level, the second emission signal may have an inactivation level, and the sweep signal may have a second voltage level higher than the first voltage level.

In some embodiments, in a third sub-emission period following the second sub-emission period of the first emission period, the first emission signal may have an activation level, the second emission signal may have an activation level, and the sweep signal may be decreased from the second voltage level to a third voltage level lower than the first voltage level.

In some embodiments, the writing frame period may further include a second emission period following the first emission period, in the first emission period, the light emitting element may emit light, and in the second emission period, the initialization voltage may be applied to the fourth node and the light emitting element may emit light.

In some embodiments, a frame period in which the pixel circuit is driven may include: a writing frame in which the data voltage is applied and the light emitting element emits light; and a holding frame in which the data voltage is not applied and the light emitting element emits light.

In some embodiments, the pixel circuit may further include: a first compensation transistor configured to connect the first node and the third node in response to the compensation gate signal; and a second compensation transistor configured to connect the fourth node and a fifth node in response to a second compensation gate signal, wherein a writing frame period in which the pixel circuit is driven includes an initialization period, a compensation period, an applying period, and a first emission period, and wherein in the initialization period, the first initialization gate signal has an activation level, the second initialization gate signal has an inactivation level, the third initialization gate signal has an activation level, and the second compensation gate signal has an inactivation level.

In some embodiments, in the compensation period following the initialization period, the third initialization gate signal may have an inactivation level, and the second compensation gate signal may have an activation level.

In some embodiments, in the applying period following the compensation period, the data voltage may be applied to the first node.

In some embodiments, in a first sub-emission period of the first emission period following the applying period, the first emission signal may have an inactivation level, the second emission signal may have an inactivation level, the second initialization gate signal may have an activation level, and the sweep signal may have a first voltage level.

In some embodiments, in a second sub-emission period following the first sub-emission period of the first emission period, the first emission signal may have an activation level, the second emission signal may have an inactivation level, and the sweep signal may have a second voltage level higher than the first voltage level.

In some embodiments, in a third sub-emission period following the second sub-emission period of the first emission period, the first emission signal may have an activation level, the second emission signal may have an activation level, and the sweep signal may be decreased from the second voltage level to a third voltage level lower than the first voltage level.

In some embodiments, the writing frame period may further include a second emission period following the first emission period, in the first emission period, the light emitting element may emit light, and in the second emission period, the initialization voltage may be applied to the fourth node and the light emitting element emits light.

According to some embodiments of the disclosure, there is provided a display apparatus including: a display panel including a pixel circuit; a gate driver configured to apply a gate signal to the display panel; a data driver configured to apply a data voltage to the display panel; an emission driver configured to apply an emission signal to the display panel; and a driving controller configured to control the gate driver, the data driver and the emission driver, wherein the pixel circuit includes: a first driving transistor including a control electrode connected to a first node, a first electrode connected to a second node and a second electrode connected to a third node; a writing transistor configured to apply the data voltage to the second node in response to a compensation gate signal; a first initialization transistor configured to apply an initialization voltage to the first node in response to a first initialization gate signal; a second initialization transistor configured to apply the initialization voltage to the third node in response to a second initialization gate signal; a second driving transistor including a control electrode connected to a fourth node, a first electrode receiving a first power voltage, and a second electrode connected to a fifth node and configured to apply a driving current; a third initialization transistor configured to apply the initialization voltage to the fourth node in response to a third initialization gate signal; a first capacitor configured to apply a sweep signal to the first node; a second capacitor including a first electrode connected to the third node and a second electrode connected to the fourth node; and a light emitting element configured to emit light based on the driving current.

In some embodiments, a writing frame period in which the pixel circuit is driven may include an applying period, a first emission period and a second emission period, in the applying period, the data voltage may be applied to the first node and the initialization voltage is applied to the fourth node, in the first emission period, the light emitting element may emit light, and in the second emission period, the initialization voltage may be applied to the fourth node and the light emitting element emits light.

According to some embodiments of the disclosure, there is provided an electronic apparatus including: a display panel including a pixel circuit; a gate driver configured to apply a gate signal to the display panel; a data driver configured to apply a data voltage to the display panel; an emission driver configured to apply an emission signal to the display panel; a driving controller configured to control the gate driver, the data driver, and the emission driver based on an input control signal; and a processor configured to output the input control signal, wherein the pixel circuit includes: a first driving transistor including a control electrode connected to a first node, a first electrode connected to a second node and a second electrode connected to a third node; a writing transistor configured to apply the data voltage to the second node in response to a compensation gate signal; a first initialization transistor configured to apply an initialization voltage to the first node in response to a first initialization gate signal; a second initialization transistor configured to apply the initialization voltage to the third node in response to a second initialization gate signal; a second driving transistor including a control electrode connected to a fourth node, a first electrode receiving a first power voltage, and a second electrode connected to a fifth node and configured to apply a driving current; a third initialization transistor configured to apply the initialization voltage to the fourth node in response to a third initialization gate signal; a first capacitor configured to apply a sweep signal to the first node; a second capacitor including a first electrode connected to the third node and a second electrode connected to the fourth node; and a light emitting element configured to emit light based on the driving current.

As described above, a W/L ratio of the second driving transistor included in the pixel circuit may be different based on a color of the light emitting element. Accordingly, the pixel circuit may not include a transistor for applying a constant current voltage. Additionally, the display apparatus may not include a line for applying the constant current voltage. Accordingly, an integration of the display apparatus including the pixel circuit may be improved. Additionally, a power consumption of the display apparatus including the pixel circuit may be reduced.

Additionally, in the display apparatus including the pixel circuit, a first emission signal may have an activation level before a second emission signal. Accordingly, the first power voltage may be applied to the first electrode of the first driving transistor included in the pixel circuit before the first driving transistor is turned on. Accordingly, an influence due to the hysteresis characteristic of the first driving transistor may be reduced.

Additionally, the pixel circuit may emit light multiple times during a writing frame period. Accordingly, an emission efficiency of the pixel circuit may be improved (e.g., increased). Additionally, a flicker phenomenon of the display apparatus including the pixel circuit may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display apparatus according to some embodiments of the present disclosure.

FIG. 2 is a circuit diagram illustrating a pixel circuit of a display panel 100 of FIG. 1 according to some embodiments of the present disclosure.

FIG. 3 is timing diagram illustrating input signals applied to the pixel circuit of FIG. 2 in a writing frame period according to some embodiments of the present disclosure.

FIG. 4 is a timing diagram illustrating input signals applied to a pixel circuit of FIG. 2 in a writing frame period according to some embodiments of the present disclosure.

FIG. 5 is a conceptual diagram illustrating a driving frequency of a display panel of FIG. 1 according to some embodiments of the present disclosure.

FIG. 6 is a timing diagram illustrating input signals applied to a pixel circuit of FIG. 2 in a holding frame period according to some embodiments of the present disclosure.

FIG. 7 is a timing diagram illustrating input signals applied to a pixel circuit of FIG. 2 in a holding frame period according to some embodiments of the present disclosure.

FIG. 8 is a circuit diagram illustrating a pixel circuit of a display panel of FIG. 1 according to some embodiments of the present disclosure.

FIG. 9 is timing diagram illustrating input signals applied to a pixel circuit of FIG. 8 in a writing frame period according to some embodiments of the present disclosure.

FIG. 10 is a timing diagram illustrating input signals applied to a pixel circuit of FIG. 8 in a writing frame period according to some embodiments of the present disclosure.

FIG. 11 is a timing diagram illustrating input signals applied to a pixel circuit of FIG. 8 in a holding frame period according to some embodiments of the present disclosure.

FIG. 12 is a timing diagram illustrating input signals applied to a pixel circuit of FIG. 8 in a holding frame period according to some embodiments of the present disclosure.

FIG. 13 is a timing diagram illustrating emission signals applied to the emission lines of a display apparatus of FIG. 1 according to some embodiments of the present disclosure.

FIG. 14 is a block diagram illustrating an electronic device according to some embodiments of the present disclosure.

FIG. 15 is a diagram illustrating an example in which the electronic device of

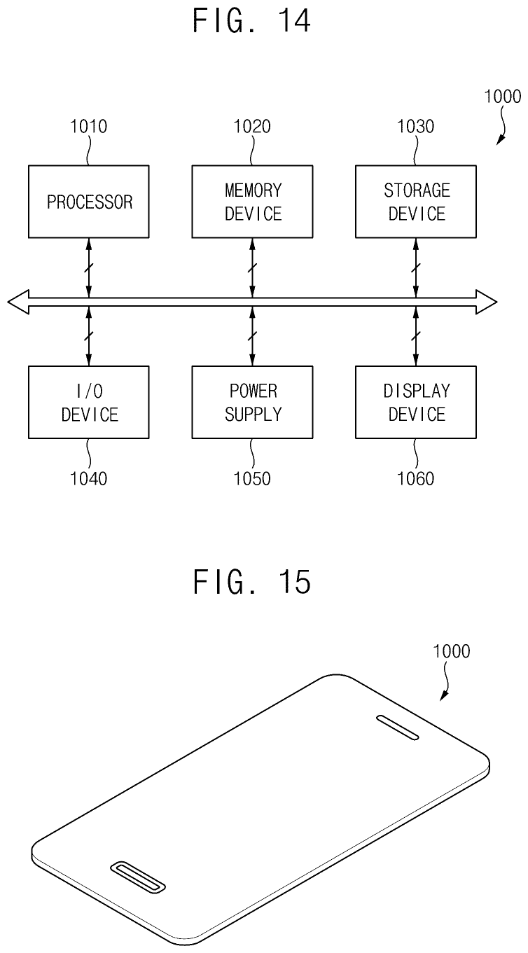

FIG. 14 is implemented as a smart phone according to some embodiments of the present disclosure.

FIG. 16 is a diagram illustrating an example in which the electronic apparatus of FIG. 14 is implemented as a smart watch according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers, and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

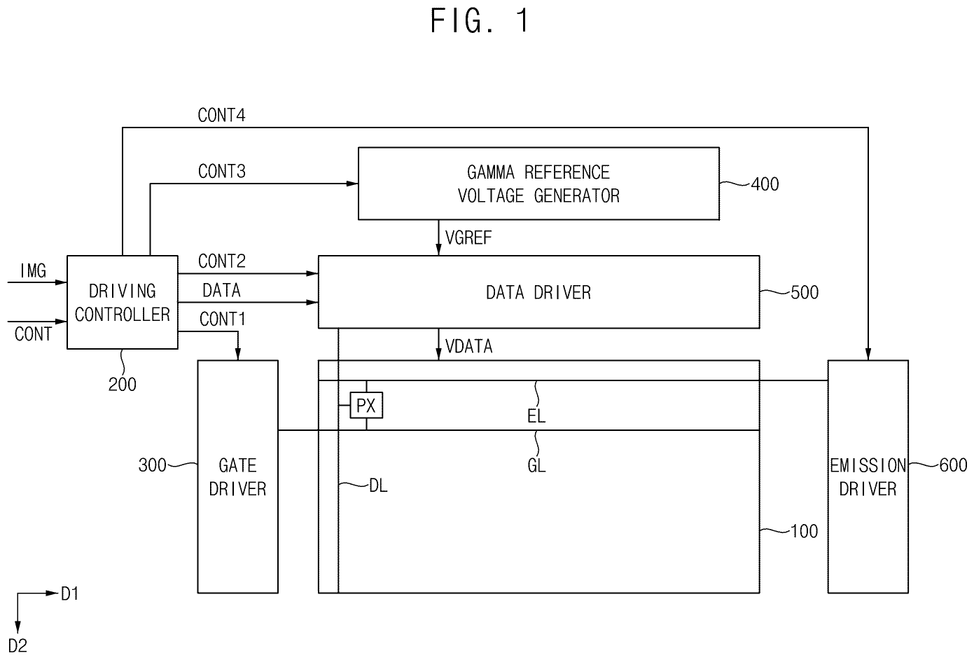

FIG. 1 is a block diagram illustrating a display apparatus according to some embodiments of the present disclosure.

Referring to FIG. 1, the display apparatus includes a display panel 100 and a display panel driver. The display panel driver may include a driving controller 200, a gate driver 300, a gamma reference voltage generator 400, a data driver 500. The display panel driver may further include an emission driver 600.

The display panel 100 has a display region on which an image is displayed and a peripheral region adjacent to the display region.

The display panel 100 may include a plurality of gate lines GL, a plurality of data lines DL, a plurality of emission lines EL, and a plurality of pixel circuit PX electrically connected to the gate lines GL, the data lines DL and the emission lines EL. The gate lines GL may extend in a first direction D1, and the data lines DL may extend in a second direction D2 crossing the first direction D1. The emission lines EL may extend in a first direction D1

The driving controller 200 may receive input image data IMG and an input control signal CONT from an external apparatus. For example, the input image data IMG may include red image data, green image data, and blue image data. The input image data IMG may include white image data. The input image data IMG may include magenta image data, cyan image data, and yellow image data. The input control signal CONT may include a master clock signal, and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT, and may output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and may output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT and may output the third control signal CONT3 to the gamma reference voltage generator 400.

The driving controller 200 may generate the fourth control signal CONT4 for controlling an operation of the emission driver 600 based on the input control signal CONT, and may output the fourth control signal CONT4 to the emission driver 600.

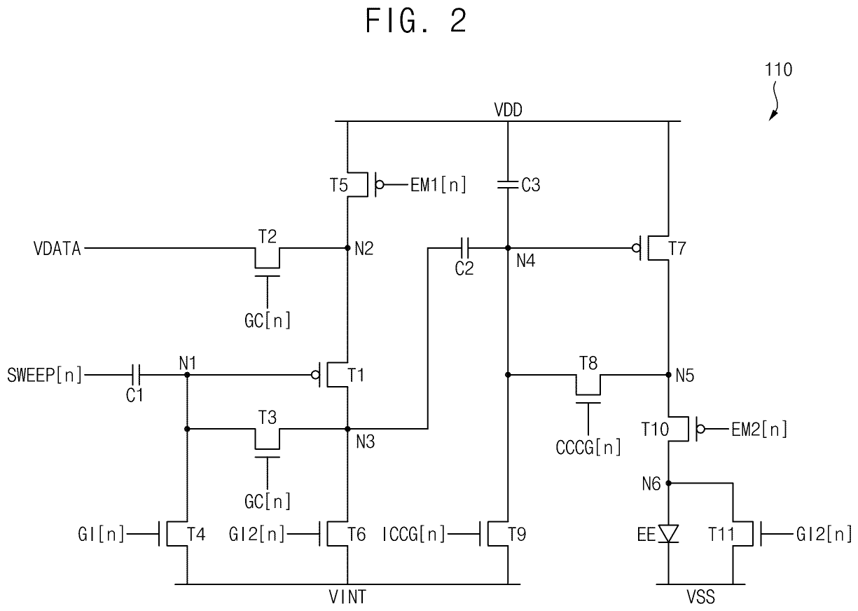

The gate driver 300 may generate gate signals driving the gate lines GL in response to the first control signal CONT1 received from the driving controller 200. The gate driver 300 may output the gate signals to the gate lines GL. For example, the gate signal may include a first initialization gate signal GI[n] of FIG. 2, a second initialization gate signal GI2[n] of FIG. 2, a compensation gate signal GC[n] of FIG. 2, a third initialization gate signal ICCG[n] of FIG. 2, and a second compensation gate signal CCCG[n] of FIG. 2.

In some embodiments, the gate driver 300 may be disposed in the peripheral region. In some embodiments, the gate driver 300 may be integrated in the peripheral region.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to a level of the data signal DATA.

For example, the gamma reference voltage generator 400 may be disposed in the driving controller 200, or in the data driver 500.

The data driver 500 may receive the second control signal CONT2 and the data signal DATA from the driving controller 200, and may receive the gamma reference voltages VGREF from the gamma reference voltage generator 400. The data driver 500 may convert the data signal DATA into data voltages VDATA having an analog type using the gamma reference voltages VGREF. The data driver 500 may output the data voltages VDATA to the data lines DL.

In some embodiments, the data driver 500 may be disposed in the peripheral region. In some embodiments, the data driver 500 may be integrated in the peripheral region.

The emission driver 600 may generate an emission signal driving the emission lines EL in response to the fourth control signal CONT4 received from the driving controller 200. The emission driver 600 may output the emission signal to the display panel 100. The emission signal may include a first emission signal EM1[n] of FIG. 2 and a second emission signal EM2[n] of FIG. 2.

In some embodiments, the emission driver 600 may be disposed in the peripheral region. In some embodiments, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the present disclosure is not limited thereto. The gate driver 300 and the emission driver 600 may be disposed on the first side of the display panel 100. For example, the gate driver 300 and the emission driver 600 may be disposed on the peripheral region of the display panel 100 on the same side of the display region of the display panel 100. For example, the gate driver 300 and the emission driver 600 may be formed integrally with each other.

In some embodiments, the display panel driver may output a sweep signal SWEEP[n] of FIG. 2 to the display panel 100.

FIG. 2 is a circuit diagram illustrating a pixel circuit PX of a display panel 100 of FIG. 1 according to some embodiments of the present disclosure.

Referring to FIG. 1 and FIG. 2, a pixel circuit 110 may include a first transistor T1, a second transistor T2, a third transistor T3, a fourth transistor T4, a fifth transistor T5, a sixth transistor T6, a seventh transistor T7, an eighth transistor T8, a ninth transistor T9, a tenth transistor T10, an eleventh transistor T11, a first capacitor C1, a second capacitor C2, a third capacitor C3, and a light emitting element EE. For example, the pixel circuit 110 may have 11T 3C structure (e.g., eleven transistors and three capacitors).

The first transistor T1 may include a control electrode (e.g., a gate electrode) connected to a first node N1, a first electrode connected to a second node N2, and a second electrode connected to a third node N3. The first transistor T1 may apply a first power voltage VDD to the third node N3 in response to a voltage of the first node N1. For example, the first transistor T1 may be called as (e.g., called) a first driving transistor. For example, the first transistor T1 may be called as a pulse width driving transistor. In some embodiments, the first transistor T1 may be a P-type transistor.

The second transistor T2 may include a control electrode receiving the compensation gate signal GC[n], a first electrode receiving the data voltage VDATA, and a second electrode connected to the second node N2. The second transistor T2 may apply the data voltage VDATA to the second node N2 in response to the compensation gate signal GC[n]. For example, the second transistor T2 may be called as a writing transistor. In some embodiments, the second transistor T2 may be an N-type transistor.

The third transistor T3 may include a control electrode receiving the compensation gate signal GC[n], a first electrode connected to the third node N3 and a second electrode connected to the first node N1. The third transistor T3 may connect the first node N1 and the third node N3 in response to the compensation gate signal GC[n]. For example, the third transistor T3 may diode-connect the first transistor T1 in response to the compensation gate signal GC[n]. Accordingly, a first driving current which a threshold voltage of the first transistor T1 is compensated may be applied to the first node N1. For example, the third transistor T3 may be called as a first compensation transistor. For example, the third transistor T3 may be called as a pulse width compensation transistor. In some embodiments, the third transistor T3 may be an N-type transistor.

The fourth transistor T4 may include a control electrode receiving the first initialization gate signal GI[n], a first electrode receiving an initialization voltage VINT, and a second electrode connected to the first node N1. The fourth transistor T4 may apply the initialization voltage VINT to the first node N1 in response to the first initialization gate signal GI[n]. For example, the fourth transistor T4 may initialize the first node N1 as the initialization voltage VINT. For example, the fourth transistor T4 may be called as a first initialization transistor. In some embodiments, the fourth transistor T4 may be an N-type transistor.

The fifth transistor T5 may include a control electrode receiving the first emission signal EM1[n], a first electrode receiving the first power voltage VDD, and a second electrode connected to the second node N2. The fifth transistor T5 may apply the first power voltage VDD to the second node N2 in response to the first emission signal EM1[n]. For example, the fifth transistor T5 may be called as a first emission control transistor. In some embodiments, the fifth transistor T5 may be a P-type transistor.

The sixth transistor T6 may include a control electrode receiving the second initialization gate signal GI2[n], a first electrode receiving the initialization voltage VINT, and a second electrode connected to the third node N3. The sixth transistor T6 may apply the initialization voltage VINT to the third node N3 in response to the second initialization gate signal GI2[n]. For example, the sixth transistor T6 may initialize the third node N3 as the initialization voltage VINT. For example, the sixth transistor T6 may be called as a second initialization transistor. In some embodiments, the sixth transistor T6 may be an N-type transistor.

The seventh transistor T7 may include a control electrode connected to a fourth node N4, a first electrode receiving the first power voltage VDD and a second electrode connected to a fifth node N5. The seventh transistor T7 may generate a driving current in response to a voltage of the fourth node N4. The seventh transistor T7 may output the driving current in response to the voltage of the fourth node N4. For example, the seventh transistor T7 may be called as a second driving transistor. For example, the seventh transistor T7 may be called as a constant current driving transistor. In some embodiments, the seventh transistor T7 may be a P-type transistor.

In some embodiments, a W/L ratio (e.g., a channel width to channel length ratio) of the seventh transistor T7 may be different based on a color of the light emitting element EE. For example, when a color of the light emitting element EE is red, the W/L ratio of the seventh transistor T7 may have a first ratio. For example, when a color of the light emitting element EE is green, the W/L ratio of the seventh transistor T7 may have a second ratio different from the first ratio. For example, when a color of the light emitting element EE is blue, the W/L ratio of the seventh transistor T7 may have a third ratio different from the first ratio and the second ratio.

In a conventional display apparatus, a constant current voltage may be applied to a constant current driving transistor. Accordingly, the conventional display apparatus may further include a line for applying the constant current voltage and a transistor for applying the constant current voltage. Accordingly, an integration of the conventional display apparatus may be deteriorated. Additionally, a power consumption of the conventional display apparatus may be increased.

In some examples, in some embodiments of the present disclosure, the W/L ratio of the seventh transistor T7 included in the pixel circuit 110 may be different based on a color of the light emitting element EE. Accordingly, the pixel circuit 110 may not include a transistor for applying the constant current voltage. Additionally, the display apparatus may not include a line for applying the constant current voltage. Accordingly, an integration of the display apparatus including the pixel circuit 110 may be improved (e.g., increased). Additionally, a power consumption of the display apparatus including the pixel circuit 110 may be reduced.

The eighth transistor T8 may include a control electrode receiving the second compensation gate signal CCCG[n], a first electrode connected to the fifth node N5 and a second electrode connected to the fourth node N4. The eighth transistor T8 may connect the fourth node N4 and the fifth node N5 in response to the second compensation gate signal CCCG[n]. For example, the eighth transistor T8 may diode-connect the seventh transistor T7 in response to the second compensation signal CCCG[n]. Accordingly, a second driving voltage by which a threshold voltage of the seventh transistor T7 is compensated may be applied to the fourth node N4. For example, the eighth transistor T8 may be called as a second compensation transistor. For example, the eighth transistor T8 may be called as a constant current compensation transistor. In some embodiments, the eighth transistor T8 may be an N-type transistor.

The ninth transistor T9 may include a control electrode receiving the third initialization gate signal ICCG[n], a first electrode receiving the initialization voltage VINT, and a second electrode connected to the fourth node N4. The ninth transistor T9 may apply the initialization voltage VINT to the fourth node N4 in response to the third initialization gate signal ICCG[n]. For example, the ninth transistor T9 may initialize the fourth node N4 as the initialization voltage VINT. For example, the ninth transistor T9 may be called as a third initialization transistor. For example, the ninth transistor T9 may be called as a constant current initialization transistor. In some embodiments, the ninth transistor T9 may be an N-type transistor.

The tenth transistor T10 may include a control electrode receiving a second emission signal EM2[n], a first electrode connected to the fifth node N5, and a second electrode connected to a sixth node N6. The tenth transistor T10 may apply the driving current to the sixth node N6 in response to the second emission signal EM2[n]. For example, the tenth transistor T10 may be called as a second emission control transistor. In some embodiments, the tenth transistor T10 may be a P-type transistor. The eleventh transistor T11 may include a control electrode receiving the

second initialization gate signal GI2[n], a first electrode receiving a second power voltage VSS, and a second electrode connected to the sixth node N6. The second power voltage VSS may be lower than the first power voltage VDD. The eleventh transistor T11 may apply the second power voltage VSS to the sixth node N6 in response to the second initialization gate signal GI2[n]. Accordingly, a black characteristic of the light emitting element EE may be improved. For example, the eleventh transistor T11 may be called as a fourth initialization transistor. For example, the eleventh transistor T11 may be called as a light emitting element initialization transistor. In some embodiments, the eleventh transistor T11 may be an N-type transistor.

The first capacitor C1 may include a first electrode receiving the sweep signal SWEEP[n] and a second electrode connected to the first node N1.

The second capacitor C2 may include a first electrode connected to the third node N3 and a second electrode connected to the fourth node N4. The second capacitor C2 may couple a voltage of the third node N3 and apply a coupling voltage to the fourth node N4.

The third capacitor C3 may include a first electrode receiving the first power voltage VDD and a second electrode connected to the fourth node N4. In some embodiments, the pixel circuit 110 may include the third capacitor C3, so that a hysteresis characteristic of the seventh transistor T7 may be improved.

The light emitting element EE may include a first electrode connected to the sixth node N6 and a second electrode receiving the second power voltage VSS. The light emitting element EE may emit light based on the driving current. For example, the light emitting element EE may be a light emitting diode. In some embodiments, the light emitting element EE may be a micro light emitting element.

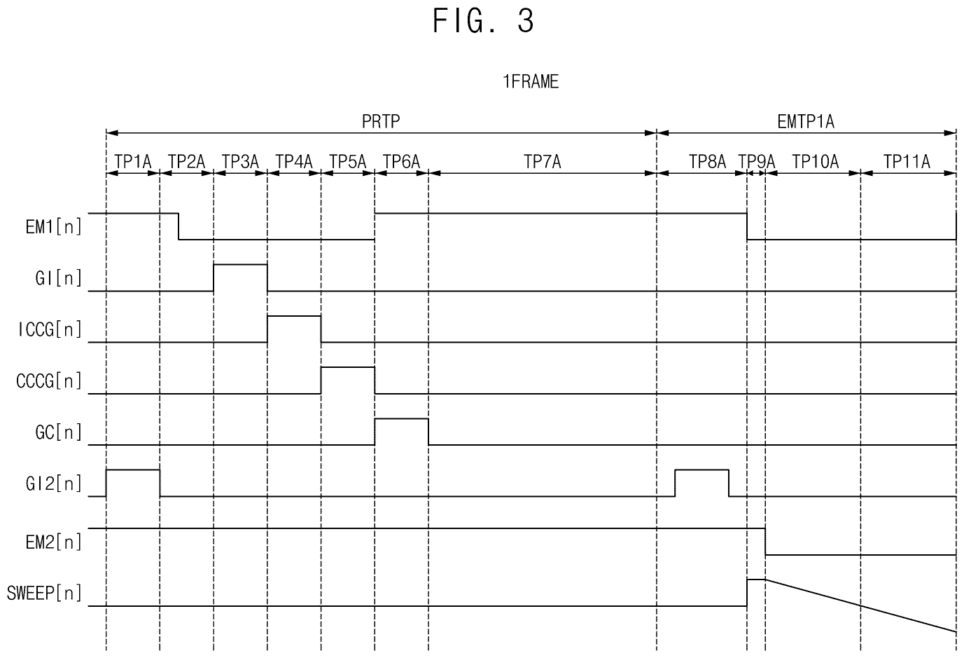

FIG. 3 is timing diagram illustrating input signals applied to a pixel circuit 110 of FIG. 2 in a writing frame period according to some embodiments of the present disclosure.

Referring to FIG. 1 to FIG. 3, in some embodiments, a writing frame period in which the pixel circuit 110 is driven may include an applying period PRTP and a first emission period EMTP1A. The applying period PRTP may include a first period TP1A, a second period TP2A, a third period TP3A, a fourth period TP4A, a fifth period TP5A, a sixth period TP6A, and a seventh period TP7A. The first emission period EMTP1A may include an eighth period TP8A, a ninth period TP9A, a tenth period TP10A, and an eleventh period TP11A.

In the first period TP1A, the first emission signal EM1[n] may have an inactivation level (i.e., may be at an inactivation level voltage), the second emission signal EM2[n] may have an inactivation level, the first initialization gate signal GI[n] may have an inactivation level, the second initialization gate signal GI2[n] may have an activation level (i.e., may be at an activation level voltage), the compensation gate signal GC[n] may have an inactivation level, the third initialization gate signal ICCG[n] may have an inactivation level, the second compensation gate signal CCCG[n] may have an inactivation level, and the sweep signal SWEEP[n] may have a first voltage level.

Herein, when a transistor to which the first emission signal EM1[n], the second emission signal EM2[n], the first initialization gate signal GI[n], the third initialization gate signal ICCG[n], the second initialization gate signal GI2[n], the compensation gate signal GC[n], and the second compensation gate signal CCCG[n] are applied is a P-type transistor, the activation level may be a low level and the inactivation level may be a high level (i.e., the activation voltage may be a low level voltage and the inactivation voltage may be a high level voltage). Conversely, when the transistor to which the first emission signal EM1[n], the second emission signal EM2[n], the first initialization gate signal GI[n], the third initialization gate signal ICCG[n], the second initialization gate signal GI2[n], the compensation gate signal GC[n] and the second compensation gate signal CCCG[n] are applied is an N-type transistor, the activation level may be a high level and the inactivation level may be a low level (i.e., the activation voltage may be a high level voltage and the inactivation voltage may be a low level voltage).

In the first period TP1A, the sixth transistor T6 may be turned on in response to the second initialization gate signal GI2[n]. Accordingly, the initialization voltage VINT may be applied to the third node N3. In the first period TP1A, the eleventh transistor T11 may be turned on in response to the second initialization gate signal GI2[n]. Accordingly, the second power voltage VSS may be applied to the sixth node N6. In the first period TP1A, the fifth transistor T5 may be turned off in response to the first emission signal EM1[n]. In the first period TP1A, the tenth transistor T10 may be turned off in response to the second emission signal EM2[n].

In the second period TP2A following the first period TP1A, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the second period TP2A, the fifth transistor T5 may be turned on in response to the first emission signal EM1[n]. Accordingly, the first power voltage VDD may be applied to the second node N2.

In the third period TP3A following the second period TP2A, the first emission signal EM1[n] may have an activation level, the second emission signal EM2[n] may have an inactivation level, the first initialization gate signal GI[n] may have an activation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the third period TP3A, the fourth transistor T4 may be turned on in response to the first initialization gate signal GI[n]. Accordingly, the initialization voltage VINT may be applied to the first node N1.

In the fourth period TP4A following the third period TP3A, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an activation level, the second compensation gate signal CCCG[n] may have an inactivation level, and the sweep signal SWEEP[n] may have the first voltage level.

In the fourth period TP4A, the ninth transistor T9 may be turned on in response to the third initialization gate signal ICCG[n]. Accordingly, the initialization voltage VINT may be applied to the fourth node N4.

In the fifth period TP5A following the fourth period TP4A, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an activation level, and the sweep signal SWEEP[n] may have the first voltage level.

In the fifth period TP5A, the eighth transistor T8 may be turned on in response to the second compensation gate signal CCCG[n]. Accordingly, the second driving voltage by which a threshold voltage of the seventh transistor T7 is compensated may be applied to the fourth node N4.

In the sixth period TP6A following the fifth period TP5A, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an activation level, the third initialization gate signal ICCG[n] may have an inactivation level, the second compensation gate signal CCCG[n] may have an inactivation level, and the sweep signal SWEEP[n] may have the first voltage level.

In the sixth period TP6A, the second transistor T2 may be turned on in response to the compensation gate signal GC[n]. In the sixth period TP6A, the third transistor T3 may be turned on in response to the compensation gate signal GC[n]. Accordingly, a voltage (e.g., the first driving voltage) based on the data voltage VDATA and a threshold voltage of the first transistor T1 may be applied to the first node N1. In the sixth period TP6A, a voltage of the third node N3 may be changed. Accordingly, a voltage of the fourth node N4 may be changed from the second driving voltage.

In the seventh period TP7A following the sixth period TP6A, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the eighth period TP8A following the seventh period TP7A, the first emission signal EM1[n] may have an inactivation level, the second emission signal EM2[n] may have an inactivation level, the first initialization gate signal GI[n] may have an inactivation level, the second initialization gate signal GI2[n] may have an activation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level. For example, the eighth period TP8A may be called as a first sub-emission period.

In the eighth period TP8A, the sixth transistor T6 may be turned on in response to the second initialization gate signal GI2[n]. Accordingly, the initialization VINT may be applied to the third node N3. Accordingly, a voltage of the fourth node N4 may be the second driving voltage. In the eighth period TP8A, the eleventh transistor T11 may be turned on in response to the second initialization gate signal GI2[n]. Accordingly, the second power voltage VSS may be applied to the sixth node N6.

In the ninth period TP9A following the eighth period TP8A, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have a second voltage level higher than the first voltage level. For example, the ninth period TP9A may be called as a second sub-emission period.

In the ninth period TP9A, the fifth transistor T5 may be turned on in response to the first emission signal EM1[n]. Accordingly, the first power voltage VDD may be applied to the second node N2.

The conventional display apparatus may start emitting light when a data voltage is applied to the first electrode of the conventional driving transistor. Accordingly, an afterimage may be recognized due to the hysteresis characteristic of the conventional driving transistor. Additionally, the conventional display apparatus may have a first frame delay.

In some examples, in the display apparatus including the pixel circuit 110, the first power voltage VDD may be applied to the second node N2 in response to the first emission signal EM1[n]. Accordingly, the first power voltage VDD may be applied to the second node N2. Accordingly, before the first transistor T1 is turned on, the first power volage VDD may be applied to the first electrode of the first transistor T1. Accordingly, an influence according to a hysteresis characteristic of the first transistor T1 may be reduced.

Additionally, in the ninth period TP9A, the sweep signal SWEEP[n] may have the second voltage level higher than the first voltage level. Accordingly, a data voltage range of the data voltage VDATA may be reduced. Accordingly, a power consumption of the display apparatus may be reduced.

In the tenth period TP10A following the ninth period TP9A, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may be decreased form the second voltage level to a third voltage level.

In the tenth period TP10A, the sweep signal SWEEP[n] may be decreased from the second voltage level to the third voltage level. For example, the sweep signal SWEEP[n] may be gradually decreased from the second voltage level to the third voltage level. The third voltage level may be lower than the first voltage level. Accordingly, a voltage of the first node N1 may be decreased. In the tenth period TP10A, the first transistor T1 may be turned off. In the tenth period TP10A, the tenth transistor T10 may be turned on in response to the second emission signal EM2[n]. Accordingly, the driving current may be applied to the light emitting element EE.

Accordingly, the light emitting element EE may emit light. For example, the tenth period TP10A may be called as an emission-on period.

In the eleventh period TP11A following the tenth period TP10A, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may be decreased to the third voltage level.

In the eleventh period TP11A, when a voltage of the first node N1 is lower than a threshold voltage of the first transistor T1, the first transistor T1 may be turned on. Accordingly, the first power voltage VDD may be applied to the third node N3. Accordingly, a voltage of the fourth node N4 may be higher than a threshold voltage of the seventh transistor T7. Accordingly, the seventh transistor T7 may be turned off. Accordingly, the light emitting element EE may stop emitting. For example, the eleventh period TP11A may be called as an emission-off period.

For example, the tenth period TP10A to the eleventh period TP11A may be called as a third sub-emission period.

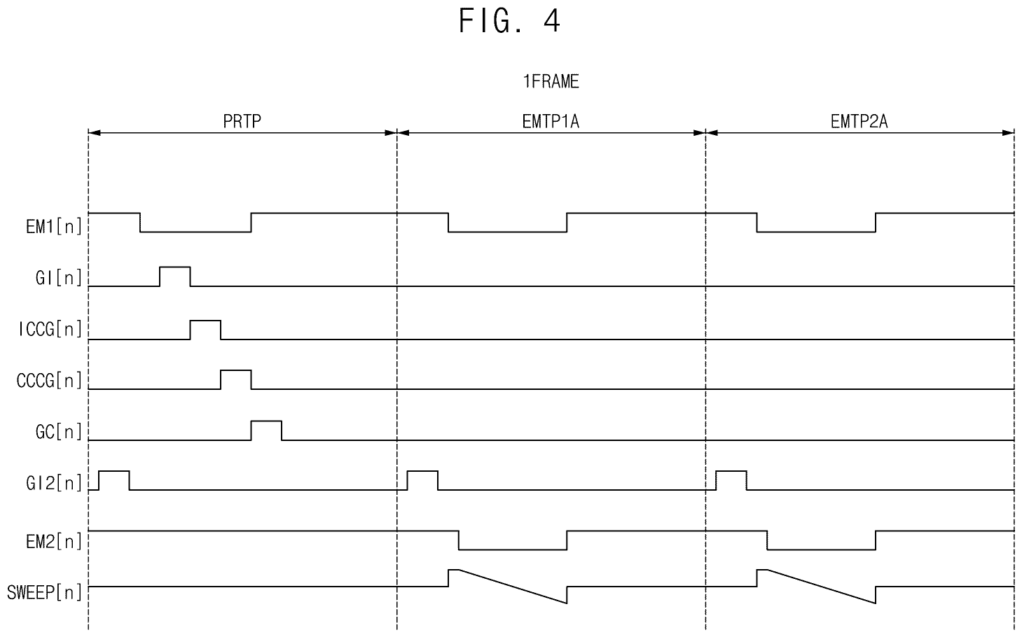

FIG. 4 is a timing diagram illustrating input signals applied to a pixel circuit 110 of FIG. 2 in a writing frame period according to some embodiments of the present disclosure.

Referring to FIG. 1 to FIG. 4, in some embodiments, a writing frame period in which the pixel circuit 110 is driven may include an applying period PRTP, a first emission period EMTP1A, and a second emission period EMTP2A. A timing of the applying period PRTP and the first emission period EMTP1A of FIG. 4 may be substantially the same as the timing of the applying period PRTP and the first emission period EMTP1A of FIG. 3. Additionally, a timing of input signals of the second emission period EMTP2A may be substantially the same as the first emission period EMTP1A. Accordingly, the same reference numerals will be used and any repetitive explanation concerning the above elements will be omitted.

In some embodiments, the writing frame period may include the applying period PRTP, the first emission period EMTP1A, and the second emission period EMTP2A. Accordingly, the pixel circuit 110 may emit light multiple times during the writing frame period. For example, the pixel circuit 110 may emit light once at a first driving frequency. In some embodiments, the pixel circuit 110 may emit light multiple times at the first driving frequency. Accordingly, the light-emitting efficiency of the pixel circuit 110 may be improved. Additionally, a flicker phenomenon of the display apparatus including the pixel circuit 110 may be reduced. Although FIG. 4 illustrates that the pixel circuit 110 emits light twice in the writing frame period, the present disclosure is not limited to the number of times of emission. For example, the pixel circuit 110 may emit light more than twice in the writing frame period.

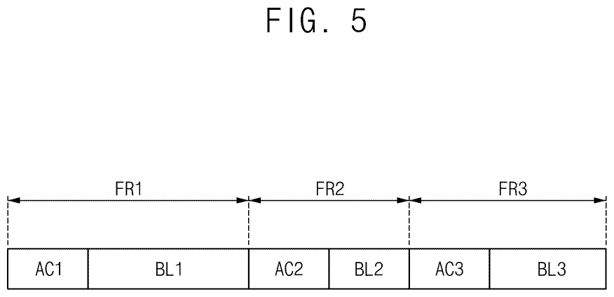

FIG. 5 is a conceptual diagram illustrating a driving frequency of a display panel 100 of FIG. 1 according to some embodiments of the present disclosure.

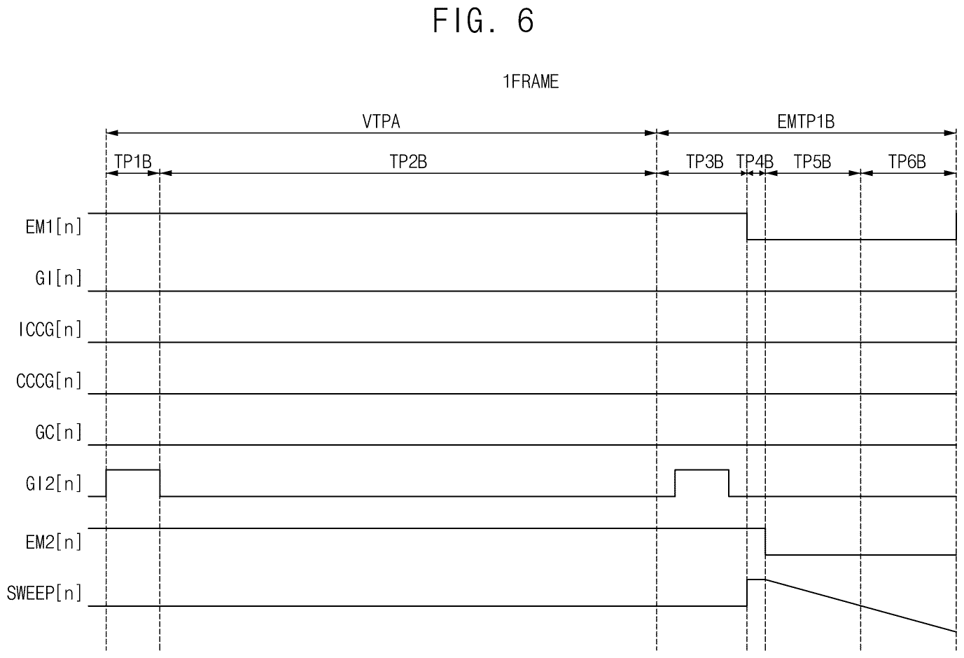

FIG. 6 is a timing diagram illustrating input signals applied to a pixel circuit 110 of FIG. 2 in a holding frame period according to some embodiments of the present disclosure.

A driving timing of the display panel 100 according to some embodiments as shown in FIG. 6 may be substantially the same as the driving timing described with reference to FIG. 2 to FIG. 4 except that the display panel 100 may be driven as a variable frequency. Accordingly, the same reference numerals will be used and any repetitive explanation concerning the above elements will be omitted.

Referring to FIG. 1, FIG. 3 to FIG. 6, the display panel 100 may be driven as the variable frequency. A first frame FR1 having a first frequency may include a first active period AC1 and a first blank period BL1. A second frame FR2 having a second frequency different from the first frequency may include a second active period AC2 and a second blank period BL2. A third frame FR3 having a third frequency different from the first frequency and the second frequency may include a third active period AC3 and a third blank period BL3.

A length of the first active period AC1 and a length of the second active period AC2 may be the same or substantially the same, and a length of the first blank period BL1 and a length of the second blank period BL2 may be different.

A length of the second active period AC2 and a length of the third active period AC3 may be the same or substantially the same, and a length of the second blank period BL2 and a length of the third blank period BL3 may be different.

A display apparatus supporting the variable frequency may include the writing frame in which a data voltage is written to a pixel and a holding frame in which the data voltage is not written to a pixel and only performs light emitting. The writing frame may be arranged within the active periods AC1, AC2, and AC3. The holding frame may be arranged within the blank periods BL1, BL2, and BL3.

For example, in the writing frame, the data voltage VDATA may be applied to the first transistor T1 and the light emitting element EE may emit light. For example, in the holding frame, the data voltage VDATA may not be applied to the first transistor T1 and the light emitting element EE may emit light.

In some embodiments, the holding frame period may include a non-applying period VTPA and a first emission period EMTP1B. The non-applying period VTPA may include a first period TP1B and a second period TP2B. The first emission period EMTP1B may include a third period TP3B, a fourth period TP4B, a fifth period TP5B, and a sixth period TP6B.

In the first period TP1B, the first emission signal EM1[n] may have an inactivation level, the second emission signal EM2[n] may have an inactivation level, the first initialization gate signal GI[n] may have an inactivation level, the second initialization gate signal GI2[n] may have an activation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the first period TP1B, the sixth transistor T6 may be turned on in response to the second initialization gate signal GI2[n]. Accordingly, the initialization voltage VINT may be applied to the third node N3. Accordingly, a voltage of the fourth node N4 may be the second driving voltage.

In the second period TP2B following the first period TP1B, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the third period TP3B following the second period TP2B, the first emission signal EM1[n] may have an inactivation level, the second emission signal EM2[n] may have an inactivation level, the first initialization gate signal GI[n] may have an inactivation level, the second initialization gate signal GI2[n] may have an activation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the first voltage level.

In the fourth period TP4B following the third period TP3B, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may have the second voltage level.

In the fourth period TP4B, the fifth transistor T5 may be turned on in response to the first emission signal EM1[n]. Accordingly, the first power voltage VDD may be applied to the second node N2.

The conventional display apparatus may start emitting light when a data voltage is applied to the first electrode of the conventional driving transistor. Accordingly, an afterimage may be recognized due to the hysteresis characteristic of the conventional driving transistor. Additionally, the conventional display apparatus may have a first frame delay.

In some examples, in the display apparatus including the pixel circuit 110, the first power voltage VDD may be applied to the second node N2 in response to the first emission signal EM1[n]. Accordingly, the first power voltage VDD may be applied to the second node N2. Accordingly, before the first transistor T1 is turned on, the first power volage VDD may be applied to the first electrode of the first transistor T1.

Accordingly, an influence according to a hysteresis characteristic of the first transistor T1 may be reduced.

Additionally, in the fourth period TP4B, the sweep signal SWEEP[n] may have the second voltage level higher than the first voltage level. Accordingly, a data voltage range of the data voltage VDATA may be reduced. Accordingly, a power consumption of the display apparatus may be reduced.

In the fifth period TP5B following the fourth period TP4B, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may be decreased from the second voltage level to the third voltage level.

In the fifth period TP5B, the sweep signal SWEEP[n] may be decreased from the second voltage level to the third voltage level. For example, the sweep signal SWEEP[n] may be gradually decreased from the second voltage level to the third voltage level. The third voltage level may be lower than the first voltage level. Accordingly, a voltage of the first node N1 may be decreased. In the fifth period TP5B, the first transistor T1 may be turned off. In the fifth period TP5B, the tenth transistor T10 may be turned on in response to the second emission signal EM2[n]. Accordingly, the driving current may be applied to the light emitting element EE. Accordingly, the light emitting element EE may emit light. For example, the fifth period TP5B may be called as the emission-on period.

In the sixth period TP6B following the fifth period TP5B, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG[n] may have an inactivation level, the second compensation gate signal CCCG[n] may have an inactivation level, and the sweep signal SWEEP[n] may be decreased to the third voltage level.

In the sixth period TP6B, when a voltage of the first node N1 is lower than a threshold voltage of the first transistor T1, the first transistor T1 may be turned on. Accordingly, the first power voltage VDD may be applied to the third node N3. Accordingly, a voltage of the fourth node N4 may be higher than a threshold voltage of the seventh transistor T7. Accordingly, the seventh transistor T7 may be turned off. Accordingly, the light emitting element EE may stop emitting. For example, the sixth period TP6B may be called as the emission-off period.

In some embodiments, in the holding frame period, the first initialization gate signal GI[n], the third initialization gate signal ICCG[n], the second compensation gate signal CCCG[n] may have an inactivation level. Accordingly, a power consumption of the display apparatus may be reduced.

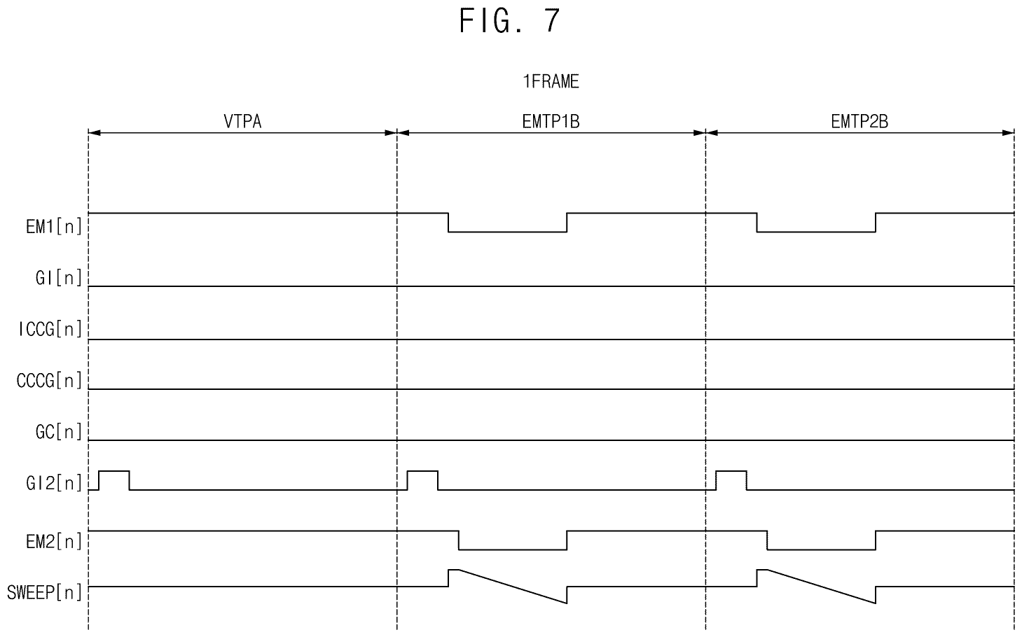

FIG. 7 is a timing diagram illustrating input signals applied to a pixel circuit 110 of FIG. 2 in a holding frame period according to some embodiments of the present disclosure.

Referring to FIG. 2 and FIG. 6 to FIG. 7, in some embodiments, a holding frame period in which the pixel circuit 110 is driven may include the non-applying period VTPA, a first emission period EMTP1B and a second emission period EMTP2B. A timing of the non-applying period VTPA and the first emission period EMTP1B of FIG. 7 may be substantially the same as the timing of the non-applying period VTPA and the first emission period EMTP1B of FIG. 6. Additionally, a timing of input signals of the second emission period EMTP2B may be substantially the same as the first emission period EMTP1B.

In some embodiments, the holding frame period may include the non-applying period VTPA, the first emission period EMTP1B, and the second emission period EMTP2B. Accordingly, the pixel circuit 110 may emit light multiple times during the holding frame period. For example, the pixel circuit 110 may emit light once at a first driving frequency. In some embodiments, the pixel circuit 110 may emit light multiple times at the first driving frequency. Accordingly, the light-emitting efficiency of the pixel circuit 110 may be improved. Additionally, a flicker phenomenon of the display apparatus including the pixel circuit 110 may be reduced. Although FIG. 7 illustrates that the pixel circuit 110 emits light twice in the holding frame period, the present disclosure is not limited to the number of times of emission. For example, the pixel circuit 110 may emit light more than twice in the holding frame period.

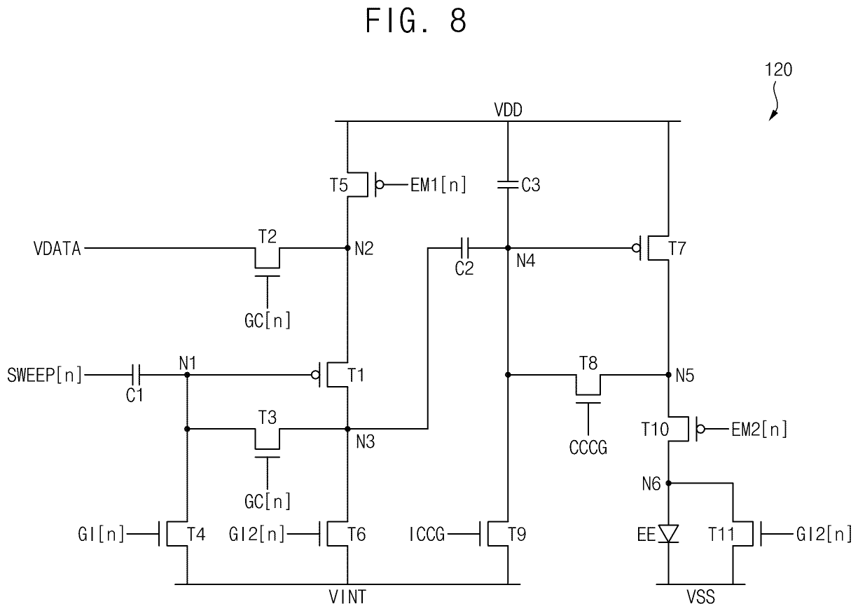

FIG. 8 is a circuit diagram illustrating a pixel circuit PX of a display panel 100 of FIG. 1 according to some embodiments of the present disclosure.

A pixel circuit 120 according to some embodiments shown in FIG. 8 is substantially the same as the pixel circuit 110 of FIG. 2, except that a third initialization gate signal ICCG and a second compensation gate signal CCCG may be global signals. Accordingly, the same reference numerals will be used and any repetitive explanation concerning the above elements will be omitted.

Referring to FIG. 8, the third initialization gate signal ICCG and the second compensation gate signal CCCG may be global signal. The global signal may be a simultaneous signal having the same timing regardless of pixel-row. For example, the global signal may have same timing across at least two pixel-rows. Accordingly, the display apparatus including the pixel circuit 120 may not include a driver for generating the third initialization gate signal ICCG and the second compensation gate signal CCCG. Accordingly, a power consumption of the display apparatus including the pixel circuit 120 may be reduced.

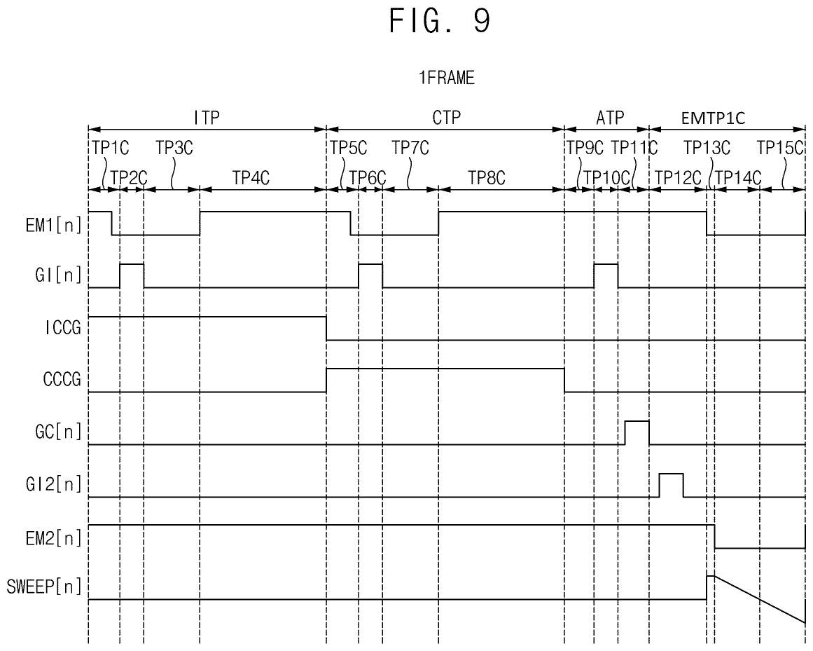

FIG. 9 is timing diagram illustrating input signals applied to a pixel circuit 120 of FIG. 8 in a writing frame period according to some embodiments of the present disclosure.

Referring to FIG. 1 and FIG. 8 to FIG. 9, in some embodiments, a writing frame period in which the pixel circuit 110 is driven may include an initialization period ITP, a compensation period CTP, an applying period ATP, and a first emission period EMTP1C. The initialization period ITP may include a first period TP1C, a second period TP2C, a third period TP3C, and a fourth period TP4C. The compensation period CTP may include a fifth period TP5C, a sixth period TP6C, a seventh period TP7C, and eighth period TP8C. The applying period ATP may include a ninth period TP9C, a tenth period TP10C, and an eleventh period TP11C. The first emission period EMTP1C may include a twelfth period TP12C, a thirteenth period TP13C, a fourteenth period TP14C, and a fifteenth period TP15C.

In the first period TP1C, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an activation level, the second compensation gate signal CCCG may have an inactivation level, and the sweep signal SWEEP[n] may have a first voltage level.

In the first period TP1C, the ninth transistor T9 may be turned on in response to the third initialization gate signal ICCG. Accordingly, the initialization voltage VINT may be applied to the fourth node N4.

In the second period TP2C following the first period TP1C, the first emission signal EM1[n] may have an activation level, the second emission signal EM2[n] may have an inactivation level, the first initialization gate signal GI[n] may have an activation level, the second initialization gate signal GI2[n] may have an inactivation level, the compensation gate signal GC[n] may have an inactivation level, the third initialization gate signal ICCG may have an activation level, the second compensation gate signal CCCG may have an inactivation level, and the sweep signal SWEEP[n] may have the first voltage level.

In the second period TP2C, the fourth transistor T4 may be turned on in response to the first initialization gate signal GI[n]. Accordingly, the initialization voltage VINT may be applied to the first node N1. Accordingly, the first transistor T1 may be turned on. In the second period TP2C, the fifth transistor T5 may be turned on in response to the first emission signal EM1[n]. Accordingly, the first power voltage VDD may be applied to the third node N3.

In the third period TP3C following the second period TP2C, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an activation level, the second compensation gate signal CCCG may have an inactivation level, and the sweep signal SWEEP[n] may have the first voltage level.

In the fourth period TP4C following the third period TP3C, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an activation level, the second compensation gate signal CCCG may have an inactivation level, and the sweep signal SWEEP[n] may have the first voltage level.

In the fifth period TP5A following the fourth period TP4A, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an activation level, and the sweep signal SWEEP[n] may have the first voltage level.

In the fifth period TP5C, the ninth transistor T9 may be turned off in response to the third initialization gate signal ICCG. In the fifth period TP5C, the eighth transistor T8 may be turned on in response to the second compensation gate signal CCCG. Accordingly, a voltage of the fourth node N4 may be the second driving voltage.

In the sixth period TP6C following the fifth period TP5C, the first emission signal EM1[n] may have an activation level, the second emission signal EM2[n] may have an inactivation level, the first initialization gate signal GI[n] may have an activation level, the second initialization gate signal GI2[n] may have an inactivation level, the compensation gate signal GC[n] may have an inactivation level, the third initialization gate signal ICCG may have an inactivation level, the second compensation gate signal CCCG may have an activation level, and the sweep signal SWEEP[n] may have the first voltage level.

In the sixth period TP6C, the fourth transistor T4 may be turned on in response to the first initialization gate signal GI[n]. Accordingly, the first power voltage VDD may be applied to the first node N1.

In the seventh period TP7C following the sixth period TP6C, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an activation level, and the sweep signal SWEEP[n] may have the first voltage level.

In the eighth period TP8C following the seventh period TP7C, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an activation level, and the sweep signal SWEEP[n] may have the first voltage level.

In the ninth period TP9C following the eighth period TP8C, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an inactivation level, and the sweep signal SWEEP[n] may have the first voltage level.

In the tenth period TP10C following the ninth period TP9C, the first emission signal EM1[n] may have an inactivation level, the second emission signal EM2[n] may have an inactivation level, the first initialization gate signal GI[n] may have an activation level, the second initialization gate signal GI2[n] may have an inactivation level, the compensation gate signal GC[n] may have an inactivation level, the third initialization gate signal ICCG may have an inactivation level, the second compensation gate signal CCCG may have an inactivation level, and the sweep signal SWEEP[n] may have the first voltage level.

In the tenth period TP10C, the fourth transistor T4 may be turned on in response to the first initialization gate signal GI[n]. Accordingly, the initialization voltage VINT may be applied to the first node N1.

In the eleventh period TP11C following the tenth period TP10C, the first emission signal EM1[n] may have an inactivation level, the second emission signal EM2[n] may have an inactivation level, the first initialization gate signal GI[n] may have an inactivation level, the second initialization gate signal GI2[n] may have an inactivation level, the compensation gate signal GC[n] may have an activation level, the third initialization gate signal ICCG may have an inactivation level, the second compensation gate signal CCCG may have an inactivation level, and the sweep signal SWEEP[n] may have the first voltage level.

In the eleventh period TP11C, the second transistor T2 may be turned on in response to the compensation gate signal GC[n]. In the eleventh period TP11C, the third transistor T3 may be turned on in response to the compensation gate signal GC[n]. Accordingly, a voltage (e.g., the first driving voltage) based on the data voltage VDATA and a threshold voltage of the first transistor T1 may be applied to the first node N1. In the eleventh period TP11C, a voltage of the third node N3 may be changed. Accordingly, a voltage of the fourth node N4 may be changed from the second driving voltage.

In the twelfth period TP12C following the eleventh period TP11C, the first emission signal EM1[n] may have an inactivation level, the second emission signal EM2[n] may have an inactivation level, the first initialization gate signal GI[n] may have an inactivation level, the second initialization gate signal GI2[n] may have an activation level, the compensation gate signal GC[n] may have an inactivation level, the third initialization gate signal ICCG may have an inactivation level, the second compensation gate signal CCCG may have an inactivation level, and the sweep signal SWEEP[n] may have the first voltage level.

In the twelfth period TP12C, the sixth transistor T6 may be turned on in response to the second initialization gate signal GI2[n]. Accordingly, the initialization VINT may be applied to the third node N3. Accordingly, a voltage of the fourth node N4 may be the second driving voltage. In the twelfth period TP12C, the eleventh transistor T11 may be turned on in response to the second initialization gate signal GI2[n]. Accordingly, the second power voltage VSS may be applied to the sixth node N6.

In the thirteenth period TP13C following the twelfth period TP12C, the first emission signal EM1[n] may have an activation level, the second emission signal EM2[n] may have an inactivation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an inactivation level, and the sweep signal SWEEP[n] may have a second voltage level higher than the first voltage level.

In the thirteenth period TP13C, the fifth transistor T5 may be turned on in response to the first emission signal EM1[n]. Accordingly, the first power voltage VDD may be applied to the second node N2.

The conventional display apparatus may start emitting light when a data voltage is applied to the first electrode of the conventional driving transistor. Accordingly, an afterimage may be recognized due to the hysteresis characteristic of the conventional driving transistor. Additionally, the conventional display apparatus may have a first frame delay.

In some examples, in the display apparatus including the pixel circuit 120, the first power voltage VDD may be applied to the second node N2 in response to the first emission signal EM1[n]. Accordingly, the first power voltage VDD may be applied to the second node N2. Accordingly, before the first transistor T1 is turned on, the first power volage VDD may be applied to the first electrode of the first transistor T1. Accordingly, an influence according to a hysteresis characteristic of the first transistor T1 may be reduced.

Additionally, in the thirteenth period TP13C, the sweep signal SWEEP[n] may have the second voltage level higher than the first voltage level. Accordingly, a data voltage range of the data voltage VDATA may be reduced. Accordingly, a power consumption of the display apparatus may be reduced.

In the fourteenth period TP14C following the thirteenth period TP13C, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an inactivation level, and the sweep signal SWEEP[n] may be decreased from the second voltage level to a third voltage level.

In the fourteenth period TP14C, the sweep signal SWEEP[n] may be decreased from the second voltage level to the third voltage level. For example, the sweep signal SWEEP[n] may be gradually decreased from the second voltage level to the third voltage level. The third voltage level may be lower than the first voltage level. Accordingly, a voltage of the first node N1 may be decreased. In the fourteenth period TP14C, the first transistor T1 may be turned off. In the fourteenth period TP14C, the tenth transistor T10 may be turned on in response to the second emission signal EM2[n]. Accordingly, the driving current may be applied to the light emitting element EE. Accordingly, the light emitting element EE may emit light. For example, the fourteenth period TP14C may be called as an emission-on period.

In the fifteenth period TP15C following the fourteenth period TP14C, the first emission signal EM1[n] may have an activation level, the second emission signal EM2[n] may have an activation level, the first initialization gate signal GI[n] may have an inactivation level, the second initialization gate signal GI2[n] may have an inactivation level, the compensation gate signal GC[n] may have an inactivation level, the third initialization gate signal ICCG may have an inactivation level, the second compensation gate signal CCCG may have an inactivation level, and the sweep signal SWEEP[n] may be decreased to the third voltage level.

In the fifteenth period TP15C, when a voltage of the first node N1 is lower than a threshold voltage of the first transistor T1, the first transistor T1 may be turned on. Accordingly, the first power voltage VDD may be applied to the third node N3. Accordingly, a voltage of the fourth node N4 may be higher than a threshold voltage of the seventh transistor T7. Accordingly, the seventh transistor T7 may be turned off. Accordingly, the light emitting element EE may stop emitting. For example, the fifteenth period TP15C may be called as an emission-off period.

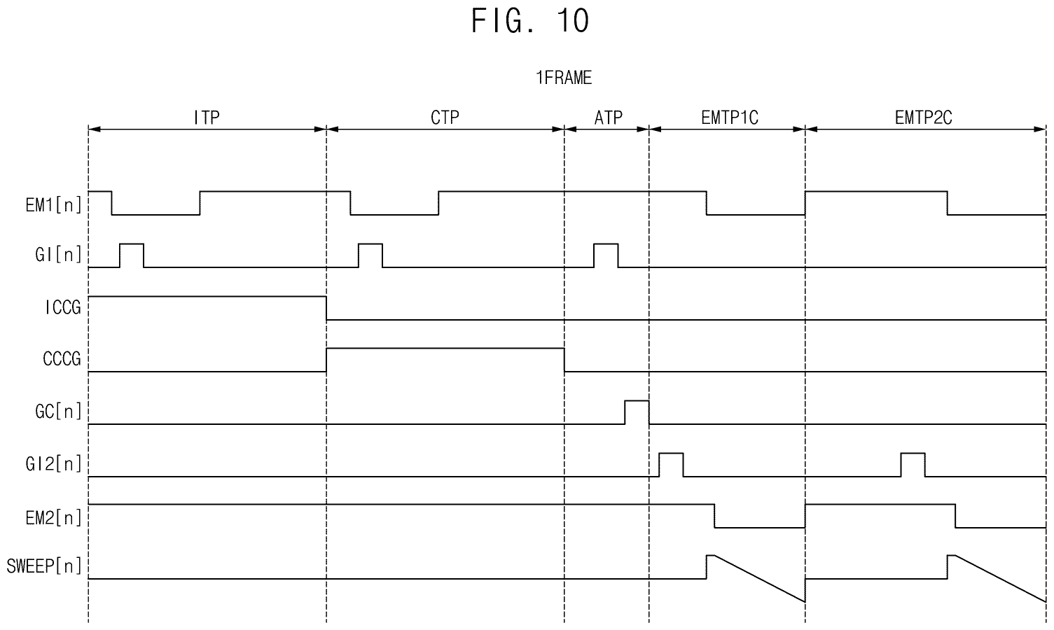

FIG. 10 is a timing diagram illustrating input signals applied to a pixel circuit 120 of FIG. 8 in a writing frame period according to some embodiments of the present disclosure.

Referring to FIG. 1 and FIG. 8 to FIG. 10, in some embodiments, a writing frame period in which the pixel circuit 120 is driven may include the initialization period ITP, the compensation period CTP, the applying period ATP, a first emission period EMTP1C and a second emission period EMTP2C. A timing of the initialization period ITP, the compensation period CTP, the applying period ATP and the first emission period EMTP1A of FIG. 10 may be substantially the same as the timing of the initialization period ITP, the compensation period CTP, the applying period ATP, and the first emission period EMTP1C of FIG. 9. Additionally, a timing of input signals of the second emission period EMTP2C may be substantially the same as the first emission period EMTP1C.

In some embodiments, the writing frame period may include the initialization period ITP, the compensation period CTP, the applying period ATP, the first emission period EMTP1C, and the second emission period EMTP2C. Accordingly, the pixel circuit 120 may emit light multiple times during the writing frame period. For example, the pixel circuit 120 may emit light once at a first driving frequency. In some embodiments, the pixel circuit 120 may emit light multiple times at the first driving frequency. Accordingly, the light-emitting efficiency of the pixel circuit 120 may be improved. Additionally, a flicker phenomenon of the display apparatus including the pixel circuit 120 may be reduced. Although FIG. 10 illustrates that the pixel circuit 120 emits light twice in the writing frame period, the present disclosure is not limited to the number of times of emission. For example, the pixel circuit 120 may emit light more than twice in the writing frame period.

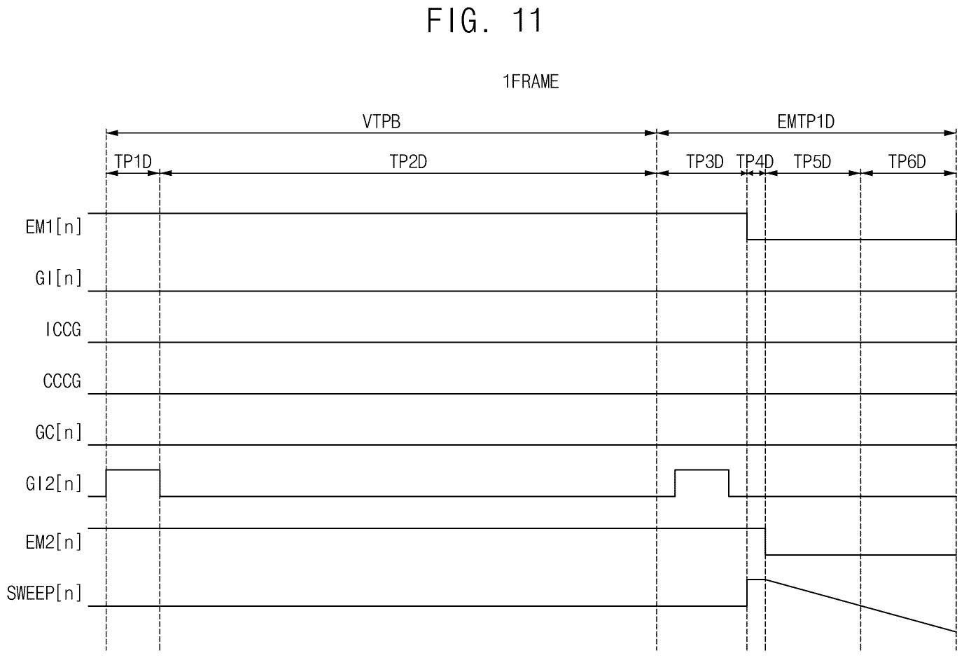

FIG. 11 is a timing diagram illustrating input signals applied to a pixel circuit 120 of FIG. 8 in a holding frame period according to some embodiments of the present disclosure.

A driving timing of the display panel 100 according to some embodiments as shown in FIG. 11 is substantially the same as the driving timing described with reference to FIG. 8 to FIG. 10 except that the display panel 100 is driven as a variable frequency, so that the same reference numerals will be used and any repetitive explanation concerning the above elements will be omitted.

In some embodiments, the holding frame period may include a non-applying period VTPB and a first emission period EMTP1D. The non-applying period VTPA may include a first period TP1D and a second period TP2D. The first emission period EMTP1D may include a third period TP3D, a fourth period TP4D, a fifth period TP5D, and a sixth period TP6D.

In some embodiments, a timing of the holding frame of FIG. 11 may be substantially the same as the timing of the holding frame of FIG. 6. Accordingly, the same reference numerals will be used and any repetitive explanation concerning the above elements will be omitted.

In some embodiments, in the holding frame period, the first initialization gate signal GI[n], the third initialization gate signal ICCG, the second gate signal CCCG may have an inactivation level. Accordingly, a power consumption of the display apparatus may be reduced.

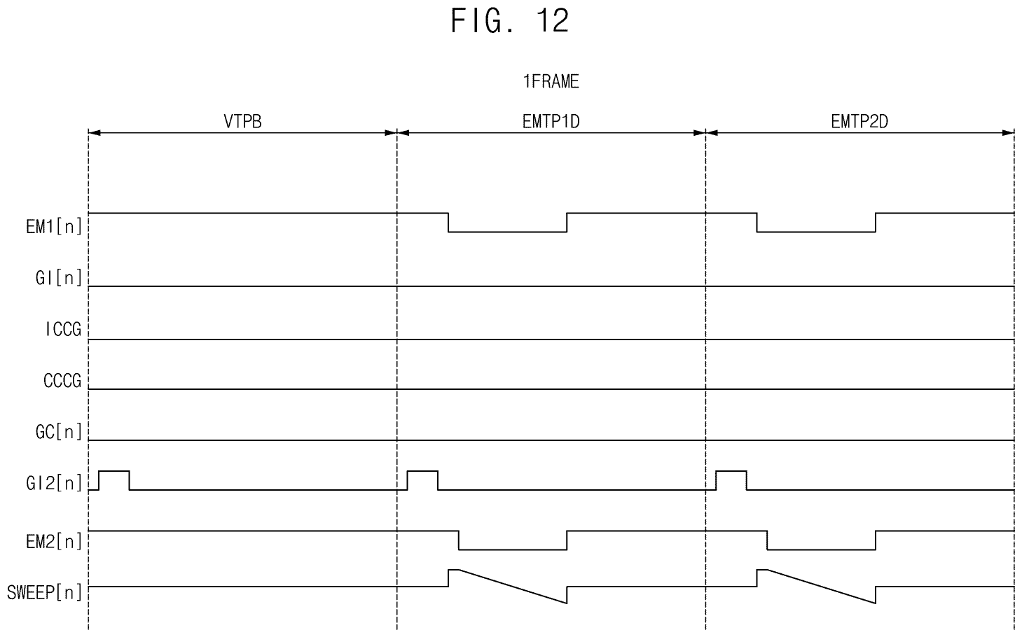

FIG. 12 is a timing diagram illustrating input signals applied to a pixel circuit 120 of FIG. 8 in a holding frame period according to some embodiments of the present disclosure.

Referring to FIG. 8 to FIG. 12, in some embodiments, a holding frame period in which the pixel circuit 120 is driven may include the non-applying period VTPB, a first emission period EMTP1D, and a second emission period EMTP2D. A timing of the non-applying period VTPB and the first emission period EMTP1D of FIG. 12 may be substantially the same as the timing of the non-applying period VTPB and the first emission period EMTP1D of FIG. 11. Additionally, a timing of input signals of the second emission period EMTP2D may be substantially the same as the first emission period EMTP1D. Accordingly, the same reference numerals will be used and any repetitive explanation concerning the above elements will be omitted.

In some embodiments, the holding frame period may include the non-applying period VTPB, the first emission period EMTP1D, and the second emission period EMTP2D. Accordingly, the pixel circuit 120 may emit light multiple times during the holding frame period. For example, the pixel circuit 120 may emit light once at a first driving frequency. In some embodiments, the pixel circuit 120 may emit light multiple times at the first driving frequency. Accordingly, the light-emitting efficiency of the pixel circuit 120 may be improved. Additionally, a flicker phenomenon of the display apparatus including the pixel circuit 120 may be reduced. Although FIG. 12 illustrates that the pixel circuit 120 emits light twice in the holding frame period, the present disclosure is not limited to the number of times of emission. For example, the pixel circuit 110 may emit light more than twice in the holding frame period.

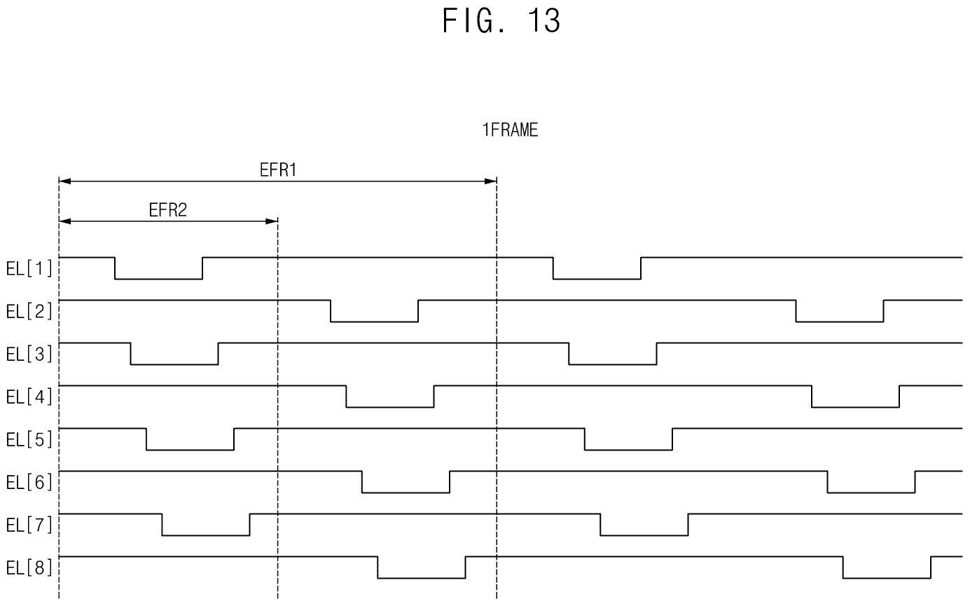

FIG. 13 is a timing diagram illustrating emission signals applied to the emission lines of a display apparatus of FIG. 1 according to some embodiments of the present disclosure.

Referring to FIG. 13, in some embodiments, an odd-numbered emission line group may include a first emission line EL[1], a third emission line EL[3], a fifth emission line EL[5], and a seventh emission line EL[7]. An even-numbered emission line group may include a second emission line EL[2], a fourth emission line EL[4], a sixth emission line EL[6], and an eighth emission line EL[8].

In some embodiments, the emission signal applied to the odd-numbered emission line group may have a first emission frequency EFR1. The emission signal applied to the even-numbered emission line group may have a first emission frequency EFR1.

The emission signal applied to the odd emission line group and the even emission line group may be applied alternately. Accordingly, even if an emission signal having the first emission frequency EFR1 is applied, display panel 100 may be recognized as a second emission frequency EFR2 higher than the first emission frequency EFR1. Accordingly, a power consumption of the display apparatus may be further reduced.

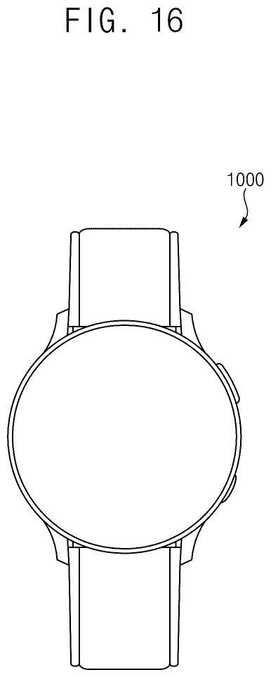

FIG. 14 is a block diagram illustrating an electronic device 1000 according to some embodiments of the present disclosure. FIG. 15 is a diagram illustrating an example in which the electronic device of FIG. 14 is implemented as a smart phone according to some embodiments of the present disclosure.

Referring to FIG. 14, the electronic device 1000 may include a processor 1010, a memory device 1020, a storage device 1030, an input/output (I/O) device 1040, a power supply 1050, and a display device 1060. Here, the display device 1060 may be the display apparatus of FIG. 1. Additionally, the electronic device 1000 may further include a plurality of ports for communicating with a video card, a sound card, a memory card, a universal serial bus (USB) device, other electronic devices, etc.

In some embodiments, as illustrated in FIG. 15, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device, and/or the like.

The processor 1010 may perform various computing functions or various tasks. The processor 1010 may be a micro-processor, a central processing unit (CPU), an application processor (AP), and/or the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, the app-on signal and the input control signal CONT (see, e.g., FIG. 1) to the driving controller 200 of FIG. 1.

The memory device 1020 may store data for operations of the electronic device 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and/or the like and/or at least one volatile memory device, such as a dynamic random access memory (DRAM) device, a static random access memory (SRAM) device, a mobile DRAM device, and/or the like.

The storage device 1030 may include a solid state drive (SSD) device, a hard disk drive (HDD) device, a CD-ROM device, and the like. The I/O device 1040 may include an input device, such as a keyboard, a keypad, a mouse device, a touch-pad, a touch-screen, and the like and an output device, such as a printer, a speaker, and the like. In some embodiments, the display device 1060 may be included in the I/O device 1040. The power supply 1050 may provide power for operations of the electronic device 1000. The display device 1060 may be coupled to other components via the buses or other communication links.

Referring to FIG. 15, the electronic device of the present disclosure is shown implemented as a smartphone, but the present disclosure is not limited thereto. The electronic device may be a television, a monitor, a laptop computer, a tablet, or the like. Additionally, the electronic device may be a car.

FIG. 16 is a diagram illustrating an example in which the electronic apparatus of FIG. 14 is implemented as a smart watch according to some embodiments of the present disclosure.

Referring to FIG. 16 and FIG. 14, the electronic device 1000 may be implemented as a smart watch. The smart watch may be an example of the electronic device 1000 utilizing an ultra-high resolution display panel.

The display apparatus according to the embodiments may be applied to a display apparatus included in a computer, a notebook, a mobile phone, a smart phone, a smart pad, a PMP, a PDA, an MP3 player, or the like.

It should be understood that embodiments described herein should be considered in a descriptive sense and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A pixel circuit comprising:
a first driving transistor comprising a control electrode connected to a first node, a first electrode connected to a second node, and a second electrode connected to a third node;
a writing transistor configured to apply a data voltage to the second node in response to a compensation gate signal;
a first initialization transistor configured to apply an initialization voltage to the first node in response to a first initialization gate signal;
a second initialization transistor configured to apply the initialization voltage to the third node in response to a second initialization gate signal;
a second driving transistor comprising a control electrode connected to a fourth node, a first electrode receiving a first power voltage, and a second electrode connected to a fifth node and configured to apply a driving current;
a third initialization transistor configured to apply the initialization voltage to the fourth node in response to a third initialization gate signal;
a first capacitor configured to apply a sweep signal to the first node;
a second capacitor comprising a first electrode connected to the third node and a second electrode connected to the fourth node; and
a light emitting element configured to emit light based on the driving current.

2. The pixel circuit of claim 1, wherein a width-to-length (W/L) ratio of the second driving transistor is different based on a color of the light emitting element.

3. The pixel circuit of claim 1, further comprising:
a first emission control transistor configured to apply the first power voltage to the second node in response to a first emission signal; and
a second emission control transistor configured to apply the driving current to the light emitting element in response to a second emission signal.

4. The pixel circuit of claim 3, further comprising:
a first compensation transistor configured to connect the first node and the third node in response to the compensation gate signal; and
a second compensation transistor configured to connect the fourth node and the fifth node in response to a second compensation gate signal.

5. The pixel circuit of claim 3, further comprising a fourth initialization transistor configured to apply a second power voltage different from the first power voltage to a first electrode of the light emitting element in response to the second initialization gate signal.

6. The pixel circuit of claim 3, wherein a writing frame period, in which the pixel circuit is driven, comprises an applying period and a first emission period, and
wherein in the applying period, the data voltage is applied to the first node and the initialization voltage is applied to the fourth node.

7. The pixel circuit of claim 6, wherein in a first sub-emission period of the first emission period, the first emission signal has an inactivation level, the second emission signal has an inactivation level, the second initialization gate signal has an activation level, and the sweep signal has a first voltage level.

8. The pixel circuit of claim 7, wherein in a second sub-emission period following the first sub-emission period of the first emission period, the first emission signal has an activation level, the second emission signal has an inactivation level, and the sweep signal has a second voltage level higher than the first voltage level.

9. The pixel circuit of claim 8, wherein in a third sub-emission period following the second sub-emission period of the first emission period, the first emission signal has an activation level, the second emission signal has an activation level, and the sweep signal is decreased from the second voltage level to a third voltage level lower than the first voltage level.

10. The pixel circuit of claim 6, wherein the writing frame period further comprises a second emission period following the first emission period,
wherein in the first emission period, the light emitting element emits light, and
wherein in the second emission period, the initialization voltage is applied to the fourth node and the light emitting element emits light.

11. The pixel circuit of claim 3, wherein a frame period in which the pixel circuit is driven comprises:
a writing frame in which the data voltage is applied and the light emitting element emits light; and
a holding frame in which the data voltage is not applied and the light emitting element emits light.

12. The pixel circuit of claim 3, further comprising:
a first compensation transistor configured to connect the first node and the third node in response to the compensation gate signal; and
a second compensation transistor configured to connect the fourth node and a fifth node in response to a second compensation gate signal,
wherein a writing frame period in which the pixel circuit is driven comprises an initialization period, a compensation period, an applying period, and a first emission period, and
wherein in the initialization period, the first initialization gate signal has an activation level, the second initialization gate signal has an inactivation level, the third initialization gate signal has an activation level, and the second compensation gate signal has an inactivation level.

13. The pixel circuit of claim 12, wherein in the compensation period following the initialization period, the third initialization gate signal has an inactivation level, and the second compensation gate signal has an activation level.

14. The pixel circuit of claim 13, wherein in the applying period following the compensation period, the data voltage is applied to the first node.

15. The pixel circuit of claim 14, wherein in a first sub-emission period of the first emission period following the applying period, the first emission signal has an inactivation level, the second emission signal has an inactivation level, the second initialization gate signal has an activation level, and the sweep signal has a first voltage level.

16. The pixel circuit of claim 15, wherein in a second sub-emission period following the first sub-emission period of the first emission period, the first emission signal has an activation level, the second emission signal has an inactivation level, and the sweep signal has a second voltage level higher than the first voltage level.

17. The pixel circuit of claim 16, wherein in a third sub-emission period following the second sub-emission period of the first emission period, the first emission signal has an activation level, the second emission signal has an activation level, and the sweep signal is decreased from the second voltage level to a third voltage level lower than the first voltage level.

18. The pixel circuit of claim 12, wherein the writing frame period further comprises a second emission period following the first emission period,
wherein in the first emission period, the light emitting element emits light, and
wherein in the second emission period, the initialization voltage is applied to the fourth node and the light emitting element emits light.

19. A display apparatus comprising:
a display panel comprising a pixel circuit;
a gate driver configured to apply a gate signal to the display panel;
a data driver configured to apply a data voltage to the display panel;
an emission driver configured to apply an emission signal to the display panel; and
a driving controller configured to control the gate driver, the data driver and the emission driver,
wherein the pixel circuit comprises:
a first driving transistor comprising a control electrode connected to a first node, a first electrode connected to a second node and a second electrode connected to a third node;
a writing transistor configured to apply the data voltage to the second node in response to a compensation gate signal;
a first initialization transistor configured to apply an initialization voltage to the first node in response to a first initialization gate signal;
a second initialization transistor configured to apply the initialization voltage to the third node in response to a second initialization gate signal;
a second driving transistor comprising a control electrode connected to a fourth node, a first electrode receiving a first power voltage, and a second electrode connected to a fifth node and configured to apply a driving current;
a third initialization transistor configured to apply the initialization voltage to the fourth node in response to a third initialization gate signal;
a first capacitor configured to apply a sweep signal to the first node;
a second capacitor comprising a first electrode connected to the third node and a second electrode connected to the fourth node; and
a light emitting element configured to emit light based on the driving current.

20. The display apparatus of claim 19, wherein a writing frame period in which the pixel circuit is driven comprises an applying period, a first emission period and a second emission period,
wherein in the applying period, the data voltage is applied to the first node and the initialization voltage is applied to the fourth node,
wherein in the first emission period, the light emitting element emits light, and
wherein in the second emission period, the initialization voltage is applied to the fourth node and the light emitting element emits light.

21. An electronic apparatus comprising:
a display panel comprising a pixel circuit;
a gate driver configured to apply a gate signal to the display panel;
a data driver configured to apply a data voltage to the display panel;
an emission driver configured to apply an emission signal to the display panel;
a driving controller configured to control the gate driver, the data driver, and the emission driver based on an input control signal; and
a processor configured to output the input control signal,
wherein the pixel circuit comprises:
a first driving transistor comprising a control electrode connected to a first node, a first electrode connected to a second node and a second electrode connected to a third node;
a writing transistor configured to apply the data voltage to the second node in response to a compensation gate signal;
a first initialization transistor configured to apply an initialization voltage to the first node in response to a first initialization gate signal;
a second initialization transistor configured to apply the initialization voltage to the third node in response to a second initialization gate signal;
a second driving transistor comprising a control electrode connected to a fourth node, a first electrode receiving a first power voltage, and a second electrode connected to a fifth node and configured to apply a driving current;
a third initialization transistor configured to apply the initialization voltage to the fourth node in response to a third initialization gate signal;
a first capacitor configured to apply a sweep signal to the first node;
a second capacitor comprising a first electrode connected to the third node and a second electrode connected to the fourth node; and
a light emitting element configured to emit light based on the driving current.
